(19) United States
(12) Patent Application Publication
(10) Pub. No.: US 2025/0136864 A1
(43) Pub. Date: May 1, 2025

(54) Precursor Composition and Method of Preparation Thereof, Inorganic Nanocrystals Preparation Method

(71) Applicants: ZHEJIANG UNIVERSITY, Hangzhou, Zhejiang (CN); Najing Technology Corporation Limited, Hangzhou, Zhejiang (CN)

(72) Inventors: Jiongzhao LI, Hangzhou, Zhejiang (CN); Xiaogang PENG, Hangzhou, Zhejiang (CN); Xiaofei HU, Hangzhou, Zhejiang (CN)

(21) Appl. No.: 18/692,332

(22) PCT Filed: Sep. 15, 2022
(86) PCT No.: PCT/CN2022/119160

§ 371 Date: Mar. 15, 2024

(30) Foreign Application Priority Data
Sep. 16, 2021 (CN) 202111083434.9

(51) Int. Cl. C09K 11/88; B82Y 20/00; B82Y 40/00; C01B 19/00; C01B 25/08; C01G 11/02; C01G 21/21; C01G 49/08; C09K 11/08; C09K 11/60; C09K 11/62; C09K 11/66

(52) U.S. Cl. CPC C09K 11/883; C01B 19/007; C01B 25/087; C01G 11/02; C01G 21/21; C01G 49/08; C09K 11/0883; C09K 11/602; C09K 11/62; C09K 11/661; C09K 11/881; B82Y 20/00; B82Y 40/00; C01P 2002/72; C01P 2002/84; C01P 2004/04; C01P 2006/60

(57) ABSTRACT

The present disclosure provides a precursor composition and a method for preparing inorganic nanocrystals. The precursor composition is used to prepare inorganic nanocrystals and is in the form of a gel, the precursor composition includes a precursor and an organogel medium for dispersing the precursor, and the precursor is one or more of a cationic precursor, an anionic precursor. The precursor composition not only greatly expands the selection range of potential precursors and their concentration range, but also simplifies the synthesis system of the nanocrystals and minimizes the impact on the environment, and improves the stability or repeatability of the method of preparing the inorganic nanocrystals.

### CROSS-REFERENCE TO RELATED APPLICATIONS

This application claims priority to Chinese Patent Application No. 202111083434.9 filed on Sep. 16, 2021, the disclosure of which is incorporated by reference in its entirety.

### TECHNICAL FIELD

The present disclosure relates to the technical field of colloidal nanocrystal preparation, and more specifically, to a precursor composition and a method of preparation thereof, and a method of preparing inorganic nanocrystals.

### BACKGROUND

The synthetic chemistry of colloidal nanocrystals, especially inorganic semiconductor nanocrystals, has made significant progress in the last two decades, facilitating their applications in displays, solar cells, biomedical labeling, photocatalysis, and more. Typically, to ensure single-crystal structures, high-quality inorganic nanocrystals are synthesized using cationic and anionic precursors in high-boiling hydrocarbon solvents. Dimethylcadmium, a typical organometallic precursor, was introduced into the synthesis of sulfur-based cadmium nanocrystals in the early 1990s, achieving quantum-confined structural absorption and sharp band-edge photoluminescence. At the beginning of the 21st century, “green synthesis method” for alternative precursors of organometallic precursors was discovered-such as the replacement of dimethylcadmium by cadmium oxide dissolved in fatty acids, thus expanding the range of high-quality nanocrystals, drastically reducing their production costs, and greatly improving the safety and environmentally friendly features of the production process. On the other hand, thioureas and thiocarbonates with different organic groups soluble in biphenyl ethers as co-solvents in hydrocarbon solvents have been developed as sulfur precursors for the high-yield synthesis of PbS and CdS nanocrystals. III-V semiconductor nanocrystals are not yet synthesized in a mature manner, and the exploration of suitable precursor has been seen as a promising solution for a long time. Although these and other developments in precursor chemistry have facilitated the synthesis of colloidal nanocrystals, it still falls short on many conflicting requirements. For example, there is a need for precursors to contain inorganic element and for them to be soluble in hydrocarbon solvents, as well as a need for stability and controlled reactivity at elevated temperatures. The evolving industrial mass production of high-quality nanocrystals, which needs to be low-cost and environmentally friendly, poses further challenges for precursor chemistry.

### SUMMARY

It is an object of the present disclosure to provide a precursor composition and a method of preparation thereof, and a method of preparation of inorganic nanocrystals.

In a first aspect of the present disclosure, there is provided a precursor composition, the precursor composition is used to prepare inorganic nanocrystals and is in the form of a gel, the precursor composition includes a precursor and an organogel medium for dispersing the precursor, the precursor being one or more of a cationic precursor, an anionic precursor.

Further, the organogel medium includes hydrocarbons of different chain lengths.

Further, the organogel medium is Vaseline.

Further, the precursor composition further includes a hydrocarbon solvent.

Further, the hydrocarbon solvent is 1-octadecene.

Further, the volume ratio of hydrocarbon solvent to organogel medium is less than or equal to 4, preferably 4/6 to 7/3.

Further, the hydrocarbon solvent has a boiling point greater than or equal to 150° C.

Further, the precursor is selected from one or more of the group consisting of a metal hydroxide, a metal carbonate, a metal carboxylate, an acetylacetone metal salt, a Se powder, a S powder, or a thiourea derivative.

Further, the precursor composition further includes an organic ligand compound for preparing inorganic nanocrystals.

Further, the precursor composition further includes a fatty acid.

Further, the fatty acid has a melting point greater than or equal to 30° C.

In a second aspect of the present disclosure, there is provided a method of preparing the precursor composition of any one of the foregoing, a precursor mixture liquid is mixed with a melted organogel medium and cooled to obtain the precursor composition.

Further, the precursor and the hydrocarbon solvent are mixed to obtain a precursor mixture liquid, the melted organogel medium is added to the precursor mixture liquid and cooled to obtain the precursor composition.

Further, the melted organogel medium is at a temperature of 70 to 80° C.

Further, the process of mixing the precursor and the hydrocarbon solvent includes mixing the precursor and the hydrocarbon solvent under one or both of sonication, agitation to obtain a precursor mixture liquid.

Further, the process of mixing the precursor and the hydrocarbon solvent further includes heating the precursor mixture liquid, but the temperature of the precursor mixture liquid is less than 100° C.

Further, the metal oxide and fatty acid are mixed and reacted to obtain the precursor mixture liquid.

Further, the volume ratio of the fatty acid to the melted organogel medium is less than or equal to 0.5.

Further, the preparation of inorganic nanocrystals is carried out using any one or more of the above precursor compositions.

Further, in the process of preparing the inorganic nanocrystals, the precursor composition is added to the reaction system in multiple supplemental additions.

Further, the precursor composition includes a metal hydroxide and the surface ligand of the prepared inorganic nanocrystals includes hydroxide.

Currently high-quality inorganic nanocrystals are synthesized only in hydrocarbon solvents, which is largely complicated by the lack of simple precursors containing inorganic elements that are soluble in solvents at ambient temperature. Application of the technical solutions of the present disclosure greatly extends the range of potential precursors and their concentration range, and simplifies the synthesis system and minimizes the impact on the environment and improves the stability or reproducibility of the method of preparation of inorganic nanocrystals.

### BRIEF DESCRIPTION OF THE DRAWINGS

The accompanying drawings of the specification, which form part of this application, are used to provide a further understanding of the present disclosure, and the schematic embodiments of the disclosure and their illustrations are used for the purpose of explaining the present disclosure and do not constitute an improper limitation of the disclosure. In the accompanying drawings:

FIG. 1 illustrates the UV-vis absorption and photoluminescence (PL) spectra of CdSe nanocrystals prepared in Example 1.

FIG. 2 illustrates a transmission electron microscope (TEM) photograph of CdSe nanocrystals prepared in Example 1.

FIG. 3 shows photographs of Se gel precursor with different Vaseline volume fractions used in Example 2 after one week of storage.

FIG. 4 illustrates the temporal evolution of the UV-vis absorption and PL spectra of CdSe nanocrystals with time as the Se gel precursor is added dropwise for Example 2.

The top panel of FIG. 5 illustrates temporal evolution of the absorbance at 380 nm of CdSe nanocrystals during the reaction process of Example 2, the bottom panel of FIG. 5 illustrates temporal evolution of the photoluminescence peak position and full width at half maxima (FWHM) of CdSe nanocrystals during the reaction process of Example 2, and the error bars show the range of deviations between the five repetitions of the reaction.

FIG. 6 illustrates the changes in each optical property during the reaction of Example 2 in five sets of replicate experiments.

FIG. 7 illustrates the UV-vis absorption and PL spectra of CdS nanocrystals prepared in Example 3.

FIG. 8 illustrates the UV-vis absorption spectrum of the CdS clusters prepared in Example 3.

FIG. 9 illustrates the UV-vis absorption and PL spectra of ZnSe nanocrystals of different sizes obtained by the preparation of Example 4.

FIG. 10 illustrates the PL FWHM versus PL peak position variation curve for ZnSe nanocrystals of different sizes prepared in Example 4.

FIG. 11 illustrates the PL spectrum of ZnSe nanocrystals prepared in Example 5.

FIG. 12 illustrates a TEM photograph of ZnSe nanocrystals prepared in Example 5.

FIG. 13 illustrates the UV-vis absorption spectra of the products during the reaction process of Example 6.

FIG. 14 illustrates a TEM photograph of CdSe nanoplatelets prepared in Example 6.

FIG. 15 illustrates a TEM photograph of the products during the reaction process of Examples 7-8.

FIG. 16 illustrates the UV-vis and PL spectra of CdSe/CdS and CdSe/CdS/ZnS nanocrystals prepared in Examples 7-8.

FIG. 17 illustrates the transient fluorescence spectra of CdSe/CdS and CdSe/CdS/ZnS nanocrystals prepared in Examples 7-8.

FIG. 18 illustrates the UV-vis and PL spectra of the CdSe cores used in Example 9 and the CdSe/ZnSe nanocrystals obtained with different numbers of monolayer.

FIG. 19 illustrates the PL spectra of CdSe cores and CdSe/ZnSe nanocrystals with one monolayer of ZnSe used in Example 9 at the same excitation intensity.

FIG. 20 illustrates a TEM photograph of CdSe/ZnSe nanocrystals with 7 monolayers of ZnSe prepared in Example 9.

FIG. 21 illustrates the UV-vis spectrum of the PbS nanocrystals obtained from the preparation of Example 10, and the inset is a TEM photograph thereof.

FIG. 22 illustrates an X-ray diffraction (XRD) pattern of the PbS nanocrystalline powder obtained from the preparation of Example 10.

FIG. 23 illustrates an XRD plot of the Fe₃O₄ nanocrystalline powder prepared in Example 12.

FIG. 24 illustrates a TEM photograph of Fe₃O₄ nanocrystals prepared in Example 12.

FIG. 25 illustrates the UV-vis and PL spectra of the nanocrystals obtained by adding different P precursors during the reaction of Example 13.

FIG. 26 illustrates a photograph of gel-like precursor compositions used in various examples.

FIG. 27 illustrates the PL spectra of the nanocrystals obtained from Example 14 and Comparison Example 1.

### DETAILED DESCRIPTION

It should be noted that the following detailed descriptions are all illustrative and are intended to provide further clarification of the present application. Unless otherwise indicated, all technical and scientific terms used herein have the same meaning as is commonly understood by one of ordinary skill in the art to which this application belongs. If not otherwise defined, all terms in the specification, including technical and scientific terms, may be defined as commonly understood by those of ordinary skill in the art. Terms defined in commonly used dictionaries may be interpreted without idealization or exaggeration unless expressly defined. Furthermore, unless expressly described to the contrary, the words “including (comprising)” will be understood to mean including the elements stated, but not excluding any other elements.

According to a first aspect of the present disclosure, there is provided a precursor composition, the precursor composition is used to prepare inorganic nanocrystals and is in the form of a gel, the precursor composition including a precursor and an organogel medium dispersing said precursor, the precursor being one or more of a cationic precursor, an anionic precursor, or more.

For precursors that are not soluble in the organogel medium or can be miscibile with the organogel medium, a semi-solidified organogel medium is used to fix the state of uniform dispersion of the precursors, which brings the following benefits: the use of organogel medium greatly expands the range of potential precursors and their concentration, such as precursors that cannot be uniformly and stably dispersed in conventional dispersants or precursors that cannot be highly concentrated (otherwise difficult to disperse uniformly) in conventional dispersants but can be uniformly and stably dispersed by using an organogel medium. Uniformly and stably dispersed precursor composition improve the stability or reproducibility of inorganic nanocrystal preparation methods. By introducing an organogel medium, environmentally hazardous organic solvents (e.g., TOP) can be partially or completely replaced, thereby reducing the environmental impact. In the preparation of inorganic nanocrystals, the organogel medium further becomes part of the reaction medium.

The main reason for the precursor compositions to be gel-like is the organogel medium, which is an organic compound or a mixture of organic compounds, and which is semi-liquid and gel-like at low or normal temperatures. The organogel medium is selected according to the actual situation, such as selecting a suitable viscosity to facilitate that the precursor can be dispersed uniformly therein. In some preferred embodiments, the viscosity range is the same as that of commercialized toothpaste.

The material of the organogel medium is unlimited and can be screened in terms of its not adversely affecting the nanocrystal synthesis reaction. The organogel medium may include hydrocarbons of different chain lengths, which as a whole exhibit a gel state at low or ambient temperatures (ambient temperature less than or equal to 40° C.). For example, long-chain docosane is mixed with liquid dodecane in different ratios, and a certain amount of hexadecane is added appropriately to obtain the organogel medium.

In some embodiments, the boiling point of the organogel medium is greater than or equal to 300° C. In other embodiments, the melting point of the organogel medium is greater than or equal to 60° C. If the organogel medium is a mixture, the range of boiling or melting points falls into the preceding range.

In some embodiments, the organogel medium is Vaseline. Vaseline is low cost and may reduce production cost. Vaseline is structurally and chemically similar to the most common solvent used to synthesize high-quality colloidal nanocrystals (1-octadecene, ODE), and in the preparation of inorganic nanocrystals, the Vaseline melts and then simply becomes part of the reaction solvent without interfering with the reaction.

The precursor and the melted organogel medium may or may not be miscible. The precursor is homogeneously dispersed in the above composition, and the precursor may include one or more than one type of precursor, such as both anionic precursor and cationic precursor, as required by the reaction conditions for the preparation of the inorganic nanocrystals.

In some embodiments, the inorganic nanocrystals may be metallic nanocrystals or non-metallic nanocrystals, the metallic nanocrystals may be noble metal nanocrystals, and the non-metallic nanocrystals may be semiconductor nanocrystals. When the inorganic nanocrystals are semiconductor nanocrystals, in some embodiments, the cationic precursors include, but are not limited to, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, zinc hydroxide, iron acetate, ferric acetylacetonate, iron iodide, ferric bromide, ferric chloride, ferric fluoride, iron carbonate, ferric cyanide, ferric nitrate, ferric oxide, ferric peroxide, ferric perchlorate, ferric sulfate, ferric hydroxide, cadmium acetate, cadmium hydroxide, cadmium acetylacetonate, cadmium iodide, cadmium bromide, cadmium chloride, cadmium fluoride, cadmium carbonate, cadmium nitrate, cadmium oxide, cadmium perchlorate, cadmium phosphide, cadmium sulfate, mercury acetate, mercury iodide, mercury bromide, mercury chloride, mercury fluoride, mercury cyanide, mercury nitrate, mercury oxide, mercury perchlorate, mercury sulfate, mercury carbonate, mercury hydroxide, lead acetate, lead bromide, lead chloride, lead fluoride, lead oxide, lead perchlorate, lead nitrate, lead sulfate, lead carbonate, lead hydroxide, tin acetate, tin hydroxide, tin bis(acetylacetonate), tin bromide, tin chloride, tin fluoride, tin oxide, tin sulfate, germanium tetrachloride, germanium oxide, germanium acetate, gallium chloride, gallium fluoride, gallium oxide, gallium nitrate, gallium sulfate, indium acetate, indium hydroxide, indium chloride, indium oxide, indium nitrate, indium sulfate, thallium acetate, thallium acetylacetonate, thallium chloride, thallium oxide, thallium ethoxide, thallium nitrate, thallium sulfate, and thallium carbonate. Depending on the composition of the nanocrystals desired to be synthesized, they may be used alone or in combinations of at least two of the foregoing compounds. In other embodiments, the cationic precursor used to synthesize the perovskite quantum dots may be any known or future developed precursor, including, but not limited to, cesium acetate, cesium chloride, and lead acetate.

When the inorganic nanocrystal is a semiconductor nanocrystal, in some embodiments, the anionic precursor includes, but is not limited to, a group V element, a compound including a group V element, a group VI element, or a compound including a group VI element. Specific examples may include, but are not limited to, sulfur(S), selenium (Se), selenide, tellurium, telluride, phosphorus (P), arsenic (As), arsenide, nitrogen (N) or nitrogen-containing compounds, hexanethiols, octanethiols, decanethiols, dodecanethiols, hexadecanethiols, thiourea derivatives, thiocarbonate derivatives, mercapto-propylsilanes, sulfur-tri-octylphosphine (S-TOP), sulfur-tertiary butylphosphine (S-TBP), sulfur-triphenylphosphine (S-TPP), sulfur-trioctylamine (S-TOA), bis(trimethylsilyl) sulfide, ammonium sulfide, sodium sulfide, selenium-trioctylphosphine (Se-TOP), selenium-tributylphosphine (Se-TBP), selenium-triphenylphosphine (Se-TPP), tellurium-tributylphosphine (Te-TBP), tellurium-triphenylphosphine (Te-TPP), tris(trimethylsilyl)phosphine, and tris(trimethylsilyl)phosphine. (trimethylsilyl)phosphine, tris(dimethylamino)phosphine, triethylphosphine, tributylphosphine, trioctylphosphine, triphenylphosphine, tricyclohexylphosphine, Li—O—C≡P, Na—O—C≡P, K—O—C≡P, Zn—(O—C≡P)₂, Ga—(O—C≡P)₃, arsenic oxide, arsenic chloride, arsenic sulfate, arsenic bromide, arsenic iodide, nitric oxide, nitric acid, and ammonium nitrate. In other embodiments, the anionic precursor used to synthesize chalcogenide quantum dots can be any known or future developed precursor. The choice of precursor depends on the composition of the nanocrystals desired to be synthesized and may be used alone or in a combination of at least two compounds.

In some embodiments, the precursor is a solid powder that is greater than or equal to 100 mesh. 100 mesh means greater than or equal to 100 sieve holes per inch of sieve mesh, and the powder is obtained by passing through the aforementioned sieve mesh. This results in a more favorable homogeneous dispersion in the organogel medium.

The organogel medium may have a volume ratio of 100% in the composition except for the precursor, i.e., other liquid may be absent. In some embodiments, the precursor composition further includes a hydrocarbon solvent. The hydrocarbon solvent is a liquid, and the hydrocarbon solvent may include C₆-C₄₀ aliphatic hydrocarbons (e.g., alkanes, olefins, or alkynes) such as hexadecane, octadecane, octadecadienne, squalane, etc.; C₆-C₃₀ aromatic hydrocarbons such as phenyl dodecane, phenyl tetradecane, phenyl hexadecane, etc.; C₁₂-C₂₂ aromatic ethers such as phenyl ethers, benzyl ethers, etc.; and combinations thereof.

In some preferred embodiments, the hydrocarbon solvent is 1-octadecene (ODE). In some embodiments, the volume ratio of hydrocarbon solvent (i.e., ODE) to organogel medium is less than or equal to 4, preferably 4/6 to 7/3. The ratio of organogel medium affects the viscosity of the composition and has an effect on the homogeneous dispersion stability of the precursor. Within the foregoing range, the viscosity and dispersion stability of the composition are better. The precursor composition within the aforementioned preferred ratios can be stabilized within days or even weeks, which is beneficial to the stability of the raw material in the production process, and is particularly suitable for reactions in which precursors are added in multiple times during the synthesis of nanocrystals. If the hydrocarbon solvent is other compounds, the optimization of the ratio of the hydrocarbon solvent to the organogel medium can be carried out according to the actual selection, so as to synthesize higher-quality nanocrystals.

In some embodiments, the hydrocarbon solvent has a melting point less than or equal to 25° C. In other embodiments, the hydrocarbon solvent has a boiling point greater than or equal to 150° C. or greater than or equal to 250° C. to accommodate reactions for preparing inorganic nanocrystals at high temperatures.

In some preferred embodiments, the precursor is one or more of the group consisting of a metal hydroxide, a metal carbonate, a metal carboxylate, an acetylacetone metal salt, a Se powder, a S powder, or a thiourea derivative. In some preferred embodiments, the precursor is a metal nitrate, a metal halide, or a complex metal inorganic compound (e.g., a metal alkali carbonate). In the process of preparing nanocrystals, when the precursor is a metal hydroxide, the hydroxide anion reacts with H₂Se and H₂S (typical reactive precursors converted from elemental selenium and sulfur) to form H₂O as a byproduct, and thus it is a better inorganic ligand, and the chloride byproduct is the harmful and corrosive HCl. The metal carboxylate may be an acetate, stearate, oleate, and the like.

In the process of preparing nanocrystals, when precursors such as metal chloride and fluoride are used, which can act as small ligands to promote the crystal face controlled growth of inorganic nanocrystals by releasing strain from surface carboxylate ligands.

In some embodiments, the metal element in said precursor is selected from one or more of cadmium, zinc, magnesium, mercury, aluminum, gallium, indium, and lead.

In some embodiments, the thiourea derivative include N,N′-di-n-butylthiourea, N-di-n-butyl,N′-butylthiourea, and other derivatives can be found in the literature “A tunable library of substituted thiourea precursors to metal sulfide nanocrystals”, DOI: 10.1126/science.aaa2951.

In some embodiments, the precursor composition further includes an organic ligand compound for preparing the inorganic nanocrystals. Examples of organic ligand compounds may include, but are not limited to, methyl mercaptan, ethanethiol, propanethiol, butanethiol, pentanethiol, hexanethiol, octanethiol, dodecanethiol, hexadecanethiol, octadecanethiol, benzyl mercaptan, methylamine, ethylamine, propylamine, butylamine, pentylamine, hexylamine, octanamine, dodecanamine, hexadecylamine, octadecylamine, dimethylamine, diethylamine, dipropylamine, formic acid, acetic acid, propionic acid, butyric acid, pentanoic acid, hexanoic acid, heptanoic acid, octanoic acid, dodecanoic acid, hexadecanoic acid, octadecanoic acid, oleic acid, benzoic acid, phosphine e.g., substituted or unsubstituted methylphosphine (e.g., trimethylphosphine, methyldiphenylphosphine, etc.), substituted or unsubstituted ethylphosphine (e.g., triethylphosphine, ethyl diphenylphosphine, etc.), substituted or unsubstituted propylphosphine, substituted or unsubstituted butylphosphine, substituted or unsubstituted pentylphosphine, substituted or unsubstituted octylphosphine (e.g., trioctylphosphine), etc., phosphine oxide compounds such as substituted or unsubstituted methylphosphine oxides (e.g., trimethylphosphine oxides, methyldiphenylphosphine oxides, etc.), substituted or unsubstituted ethylphosphine oxides (e.g., triethylphosphine oxides, ethyldiphenylphosphine oxides, etc.), substituted or unsubstituted propylphosphine oxides, substituted or unsubstituted butylphosphine oxides, substituted or unsubstituted octylphosphine oxides (e.g., trioctylphosphine oxides, etc.), etc., diphenylphosphine compounds, triphenylphosphine compounds, oxide compounds thereof, etc., and phosphonic acids. The organic ligand compound may be used alone or as a combination of at least two of the aforementioned compounds. Preferably, the organic ligand compound is liquid at room temperature.

In some embodiments, the precursor composition further includes an inorganic ligand compound for preparing inorganic nanocrystals.

In some embodiments, the precursor composition further includes a fatty acid. For example, Se element, oleic acid, and Vaseline are mixed to obtain precursor composition in the gel state.

In some embodiments, the precursor composition further includes a fatty acid, and the fatty acid can be used as a raw material of the ligand for the nanocrystals. In other embodiments, the raw material of the cationic precursor and the fatty acid can be reacted to obtain the cationic precursor, but with an excess of fatty acid, thus the precursor composition obtained also includes the excess fatty acid. In some embodiments, the fatty acid includes one or more of formic acid, acetic acid, propionic acid, butyric acid, pentanoic acid, hexanoic acid, heptanoic acid, octanoic acid, dodecanoic acid, hexadecanoic acid, octadecanoic acid, oleic acid, benzoic acid.

In some embodiments, the fatty acid has a melting point of less than or equal to 30° C.

According to a second aspect of the present disclosure, there is provided a method of preparing a precursor composition as described above, in which a precursor mixture liquid is mixed with a melted organogel medium and cooled to obtain a precursor composition.

In some embodiments, the precursor and the hydrocarbon solvent are mixed to obtain a precursor mixture liquid, the melted organogel medium is added to the precursor mixture liquid, and cooled to obtain a precursor composition.

In some embodiments, the cooling rate is greater than or equal to 1.5° C./s to form a gel with uniformly dispersed precursor. The faster the cooling rate, the better.

In some embodiments, the melted organogel medium is at a temperature of 70 to 80° C.

In some embodiments, the process of mixing the precursor and the hydrocarbon solvent includes mixing the precursor and the hydrocarbon solvent under one or both of sonication, agitation to obtain a precursor mixture liquid. Both sonication and agitation can accelerate dispersion and improve dispersion of the precursor in the mixture. The time required for sonication can be determined on a case-by-case basis. It should be noted that “precursor mixture liquid” does not require that the precursor is 100% dissolved in the solvent, but can be a suspension.

In some embodiments, the process of mixing the precursor and the hydrocarbon solvent is at room temperature. In some embodiments, the process of mixing the precursor and the hydrocarbon solvent further includes heating the precursor mixture in liquid state, but the temperature of the precursor mixture liquid is less than 100° C. to promote dispersion of the precursor.

In some embodiments, the metal oxide and the fatty acid are mixed and reacted to obtain the precursor mixture liquid. The precursor mixture liquid includes a metal fatty acid salt.

The type of organogel medium and fatty acid can be optimized based on the actual selection. In some embodiments, the volume ratio of melted organogel medium to fatty acid is greater than or equal to 0.5, preferably greater than or equal to 0.9.

According to a third aspect of the present disclosure, there is provided a method of preparing inorganic nanocrystals using any one or more of the precursor compositions described above. High quality inorganic nanocrystals can be synthesized using the precursor compositions described above. For the precursor that is insoluble in the organogel medium or the precursor that can be soluble with an organogel medium, the state of homogeneously dispersed precursor can be fixed by means of a semi-solidified organogel medium, which results in the following advantages: the organogel medium greatly expands the range of choices of potential precursors and their concentration ranges, and the convenience of production can be improved and the cost of production can be lowered, for example, precursors that cannot be uniformly and stably dispersed in conventional dispersants, or cannot be highly concentrated in conventional dispersants (otherwise it is difficult to disperse them uniformly) can be uniformly and stably dispersed by using organogel medium. Uniformly and stably dispersed precursors improve the stability or reproducibility of inorganic nanocrystal preparation methods. The environmental impact can be reduced by introducing the organogel medium that partially or completely replaces environmentally hazardous organic solvents (e.g., TOP).

In some embodiments, the process of preparing inorganic nanocrystals is supplemented with multiple additions of precursor composition to the reaction system. The conventional precursor suspension is prone to settling and can't be dispersed uniformly, and the amount of precursor supplemented at each time cannot be completely consistent, resulting in a decrease in the controllability of the reaction. The use of the precursor composition described above can realize automated supplementation without worrying about inconsistent addition, improving the production efficiency and the quality of the nanocrystals.

In some embodiments, the volume ratio of ODE in the precursor composition to the organogel medium is less than or equal to 4, preferably 4/6 to 7/3, to improve the stability of the precursor composition in terms of uniform dispersion prior to use, and to improve the accuracy of the subsequent injection.

In some embodiments, the precursor composition includes metal hydroxide and the surface ligand of the prepared inorganic nanocrystals includes hydroxide. Nanocrystals with a surface ligand of hydroxide can be prepared using precursor composition containing metal hydroxide and Vaseline, and the resulting nanocrystals have a higher quantum yield (QY).

The nanocrystals may be prepared by wet chemical methods, and the nanocrystals may have other organic ligand compounds on the surface. The ligand compounds may be any suitable organic ligand compounds known in the art without particular limitation. For example, the organic ligand compounds may include compounds of the formula RCOOH, RNH₂, R₂NH, R₃N, RSH, RH₂PO, R₂HPO, R₃PO, RH₂P, R₂HP, R₃P, ROH, RCOOR′, RPO(OH)₂, or R₂POOH, wherein R and R′ are independently C₁-C₂₄ alkyl, C₂-C₂₄ alkenyl, or C₆-C₂₀ aryl, or combinations thereof. The organic ligand compounds may be coordinated to the surface of the nanocrystals, as prepared, to enhance the dispersion of the nanocrystals in solution, and they may be useful for the luminescent and electrical properties of the nanocrystals. Examples of the organic ligand compounds may include, but are not limited to, methyl mercaptan, ethanethiol, propanethiol, butanethiol, pentanethiol, hexanethiol, octanethiol, dodecanethiol, hexadecanethiol, octadecanethiol, benzyl mercaptan, methylamine, ethylamine, propylamine, butylamine, pentylamine, hexanamine, octanamine, dodecylamine, cetylamine, octadecylamine, dimethylamine, diethylamine, dipropylamine, formic acid, acetic acid, propionic acid, butyric acid, pentanoic acid, hexanoic acid, heptanoic acid, octanoic acid, dodecanoic acid, hexadecanoic acid, octadecanoic acid, oleic acid, benzoic acid, phosphine e.g., substituted or unsubstituted methylphosphine (e.g., trimethylphosphine, methyldiphenylphosphine, etc.), substituted or unsubstituted ethylphosphine (e.g., triethylphosphine, ethyldiphenylphosphine, etc.), substituted or unsubstituted propylphosphine, substituted or unsubstituted butylphosphine, substituted or unsubstituted pentylphosphine, substituted or unsubstituted octylphosphine (e.g., trioctylphosphine), etc., phosphine oxide compounds such as substituted or unsubstituted methylphosphine oxides (e.g., trimethylphosphine oxides, methyldiphenylphosphine oxides, etc.), substituted or unsubstituted ethylphosphine oxides (e.g., triethylphosphine oxides, ethyldiphenylphosphine oxides, etc.), substituted or unsubstituted propylphosphine oxides, substituted or unsubstituted butylphosphine oxides, substituted or unsubstituted octylphosphine oxides (e.g., trioctylphosphine oxides, etc.), etc., diphenylphosphine compounds, triphenylphosphine compounds, oxide compounds thereof, etc., and phosphonic acids. The said organic ligand compounds may be used alone or as a combination of at least two of the aforementioned compounds.

Another aspect of the present disclosure provides a semiconductor nanocrystal, the semiconductor nanocrystal has surface ligands with more than 15% being hydroxide (based on the number of all ligands). The semiconductor nanocrystal has a higher quantum yield. The surface ligand of the semiconductor nanocrystal has 15%-20%, 20%-30%, 20%-40%, 20%-50%, 20%-60%, 20%-70%, 20%-80%, 20%-90%, or 20%-100% of hydroxide ligands. In some embodiments, the semiconductor nanocrystal having the hydroxide ligand is in the shape of a cube. In some embodiments, the nanocrystals having the hydroxide ligand are CdSe/CdS or CdSe/CdS/ZnS, and the semiconductor nanocrystals have a surface ligand with hydroxide accounting for 20%±1%.

In some preferred embodiments, the semiconductor nanocrystals have a PL full width at half maxima less than or equal to 30 nm, or less than or equal to 25 nm, or less than or equal to 20 nm, or less than or equal to 15 nm, but greater than 10 nm.

The semiconductor nanocrystals of the present disclosure can include one or more semiconductor materials. Examples of semiconductor materials that may be included in the semiconductor nanocrystals include, but are not limited to, group IV elements, group II-VI compounds, group II-V compounds, group III-VI compounds, group III-V compounds, group IV-VI compounds, group I-III-VI compounds, group II-IV-VI compounds, group II-IV-V group compounds, alloys including any of the foregoing, and/or mixtures including any of the foregoing, including ternary and quaternary mixtures or alloys. Non-limiting examples of embodiments include ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AIP, AlSb, TIN, TIP, TIAs, TISb, PbO, PbS, PbSe, PbTe, Ge, Si, alloys including any of the foregoing, and/or mixtures including ternary and quaternary mixtures or alloys including any of the foregoing.

In certain preferred embodiments, semiconductor nanocrystals according to the present disclosure may include a core including one or more semiconductor materials and a shell including one or more semiconductor materials, wherein the shell is arranged on at least a portion of the core, and preferably on all exterior surface. Semiconductor nanocrystals including a core and a shell are also referred to as “core/shell” structure.

For example, the semiconductor nanocrystal may include a core having the chemical formula MX, wherein M is cadmium, zinc, magnesium, mercury, aluminum, gallium, indium, thallium, or a mixture thereof, and X is oxygen, sulfur, selenium, tellurium, nitrogen, phosphorus, arsenic, antimony, or a mixture thereof. Examples of materials suitable for use as semiconductor nanocrystal cores include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AIP, AlSb, TIN, TIP, TIAs, TISb, PbO, PbS, PbSe, PbTe, Ge, Si, alloys including any of the foregoing, and/or mixtures including any of the foregoing, including ternary and quaternary mixtures or alloys.

The shell may be a semiconductor material having a composition that is the same as or different from the core. The shell may include a coating that includes one or more semiconductor materials on the surface of the nucleus. Examples of semiconductor materials that may be included in the shell include, but are not limited to, group IV element, group II-VI compound, group II-V compound, group III-VI compound, group III-V compound, group IV-VI compound, group I-III-VI compound, group II-IV-VI compound, group II-IV-V compound, alloys including any of the foregoing, and/or mixtures including any of the foregoing, including ternary and quaternary mixtures or alloys. Examples include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgS, HgSe, HgTe, InAs, InN, InP, InSb, AlAs, AlN, AIP, AlSb, TIN, TIP, TIAs, TISb, PbO, PbS, PbSe, PbTe, Ge, Si, alloys including any of the foregoing, and/or mixtures including any of the foregoing. For example, a ZnS, ZnSe, or CdS shell layer (protective layer, overcoating) may be grown on the CdSe or CdTe semiconductor nanocrystals.

In a core/shell semiconductor nanocrystal, the shell may include one or more layers. The shell layer may include at least one semiconductor material that is the same as or different from the composition of the core. The shell layer may have a thickness of about 1 to about 10 monolayers. The shell layer may also have a thickness greater than 10 monolayers. In some embodiments, more than one shell layer may be included on the core. By adjusting the temperature of the reaction mixture during coating and monitoring the absorption spectrum of the core, the shell with a high emission quantum efficiency and a narrow size distribution can be obtained.

In certain embodiments, the band gap of the “shell” material may have a band gap that is greater than the band gap of the core material. In certain other embodiments, the bandgap of the shell material may have a bandgap that is smaller than the bandgap of the nuclear material.

In certain preferred embodiments, the core/shell semiconductor nanocrystals have a Type I structure.

Examples of semiconductor nanocrystal core/shell structures include, but are not limited to: red QDs, e.g., CdSe/CdZnS (core/shell), CdSe/ZnS/CdZnS (core/shell/shell); green QDs, e.g., CdZnS/CdZnS (core/shell), CdSe/ZnS/CdZnS (core/shell/shell); blue QDs, e.g., CdS/CdZnS (core/shell).

The semiconductor nanocrystals may have various shapes, including but not limited to spherical, rod, disk, sheet, other shapes, and mixtures of particles of various shapes.

In certain preferred embodiments of aspects of the present disclosure described herein, the semiconductor nanocrystals are undoped.

As used herein, “undoped semiconductor nanocrystals” refers to such semiconductor nanocrystals which emit light due to quantum confinement without emission from an activator.

In certain preferred embodiments of aspects of the present disclosure described herein, the semiconductor nanocrystal includes a core including a first semiconductor material, and at least a first shell surrounding the core, wherein the first shell includes a second semiconductor material. In certain such embodiments, a thickness of the first shell is greater than or equal to the thickness of 1 monolayer of the second semiconductor material. In certain such embodiments, the first shell has a thickness of up to about 10 monolayers of the second semiconductor material.

In certain preferred embodiments, the semiconductor nanocrystals can include a second shell surrounding an outer surface thereof. In certain such embodiments, the second shell can include a third semiconductor material.

In the following, the embodiments are described in more detail with reference to specific embodiments. However, they are exemplary examples of the present disclosure and the present disclosure is not limited thereto.

### Chemicals Used

Cadmium acetate dihydrate (Cd(Ac)₂·2H₂O, 98+%), cadmium oxide (CdO, 99.998%), zinc carbonate hydroxide (Zn₅(OH)₆(CO₃)₂, ≥58% Zn basis), selenium powder (Se, 200 mesh, 99.999%), 1-octadecene (ODE, 90%), lauric acid (99.5%), oleic acid (HO1, 90%), and oleylamine (≥98%) were purchased from Sigma-Aldrich. Zinc acetate dehydrate (Zn(Ac)₂·2H₂O, ≥98%), Indium acetate (In(Ac)₃, 99.99% metals basis), indium acetylacetonate (In(Acac)₃, 98%), lead (II) acetate trihydrate (Pb(Ac)₂·3H₂O), stearic acid (HSt, >98%), capric acid (HCa, 99%), sulfur powder (S, 99.98%), tetramethylammonium hydroxide (98%), N,N′-Di-n-butylthiourea (99%). and n-dodecane (99%) were purchased from Alfa-Aesar. Cadmium hydroxide (Cd(OH)₂, 98.5%) were purchased from Aladdin. Zinc acetylacetonate (Zn(Acac)₂, 98%) was purchased from Macklin. (TMS)₃P (10 wt. % in hexane, >98%) were purchased from Stream Chemicals. All organic solvents were purchased from Sinopharm Reagents. All chemicals were used directly without any further purification.

### Preparation of Cadmium Stearate

Cadmium acetate dihydrate (10 mmol) was dissolved in methanol (20 mL) in a 50 mL flask. In another flask (500 mL), stearic acid (20 mmol) and tetramethylammonium hydroxide (20 mmol) were dissolved in 100 mL of methanol by stirring for 20 min. To this solution was added the cadmium acetate solution dropwise with vigorous stirring. White precipitation indicated the formation of cadmium stearate and stirring was continued for another 20 min after completion of adding the cadmium acetate solution. The precipitate was separated and washed three times with methanol by filtration. The final precipitate was dried under vacuum at room temperature overnight before using.

### Preparation of Lead Oleate

Lead acetate trihydrate (10 mmol) was dissolved in methanol (20 mL) in a flask. In another flask (500 mL), oleic acid (20 mmol) and tetramethylammonium hydroxide (20 mmol) were dissolved in 100 mL of methanol by stirring for 20 min. To this solution was added the Lead acetate solution dropwise with vigorous stirring. White precipitation indicated the formation of lead oleate and stirring was continued for another 20 min after completion of adding the lead acetate solution. The precipitate was separated and washed three times with methanol by filtration. The final precipitate was dried under vacuum at room temperature overnight before using.

### Optical Property Measurement Methods

UV-vis spectra were taken on an Analytik Jena S600 UV-visible spectrophotometer. Photoluminescence (PL) spectra were recorded on Edinburgh Instrument FLS920. PL decay dynamics were measured on a time-correlated single-photon counting (TCSPC) spectrofluorometer (FLS920, Edinburgh Instrument, UK), and the nanocrystals were excited by a 405 nm picosecond laser diode with a 2 MHz repetition rate. The absolute PL quantum yield (QY) was measured using a calibrated Ocean Optics FOIS-1 integrating sphere coupled with a QE65000 spectrometer. All optical measurements were performed at room temperature.

TEM images were taken on a Hitachi 7700 transmission electron microscope at 100 kV, and the nanocrystals were deposited onto an ultrathin carbon film on a copper grid. XRD measurements were carried out on a Rigaku Ultimate-IV X-ray diffractometer operated at 40 kV/30 mA with a Cu Kα line (λ=1.5418 Å). Nanocrystal powder samples were placed onto glass substrates after purification by the standard precipitation procedure with hexanes as the solvent and acetone and methanol as the precipitation reagents.

### Example 1

Synthesis of spherical CdSe nanocrystals with an average diameter of 3.3 nm (first exciton absorption peak at 550 nm) using Se gel precursor.

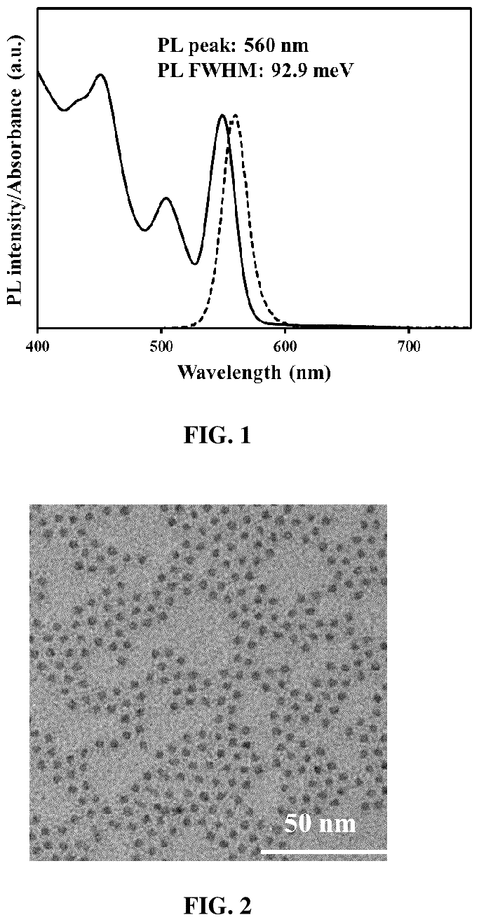

Se gel precursor (Se-Gel, 0.4M) was prepared by dispersing Se powder (0.315 g, 4.0 mmol) in ODE (6.0 mL) by sonication for 5 min. After then, Vaseline (4.0 mL) was melted and added to the above suspension. In a typical synthesis, CdO (0.0127 g, 0.8 mmol) and stearic acid (0.910 g, 3.2 mmol) were loaded into a 50 mL three-neck flask with 24.0 mL of ODE. After stirring and argon bubbling for 10 min, the mixture was heated to 280° C. by a digital-controlled heating mantle to obtain a colorless solution. The temperature was reduced to 250° C., and 1 mL of the Se-Gel was injected quickly into the hot solution. The reaction temperature was kept at 250° C. for further growth. After growth for 8 min, one dose of the Se-gel (2.0 mL) was loaded into a syringe and dropwise added into the reaction flask at 1.0 mL/h by an automated syringe pump until the first excitonic absorption peak of the nanocrystals reached 550 nm. Aliquots (0.05 mL) were taken for UV-vis and PL measurements to monitor the reaction. When the desired size was reached, the reaction was stopped by cooling down to room temperature in air. Purification was performed using the following procedure. Typically, the reaction mixture (4 mL) was loaded into a 20 mL vial. Into the vial, 4 mL ethyl acetate was added. After vortexing and centrifugation at 4000 rpm, the supernatant was removed. The precipitate was dissolved in ˜3 mL toluene. 3 mL methanol was added at room temperature and the mixture was heated at 85° C. for 5 min. After centrifuging at 4000 rpm for 15s, the supernatant was removed. The precipitation was repeated twice. Purified CdSe nanocrystals were dissolved in ODE. The photoluminescence and UV-vis absorption spectra of typical CdSe nanocrystals obtained are shown in FIG. 1, and the TEM image is shown in FIG. 2.

### Example 2

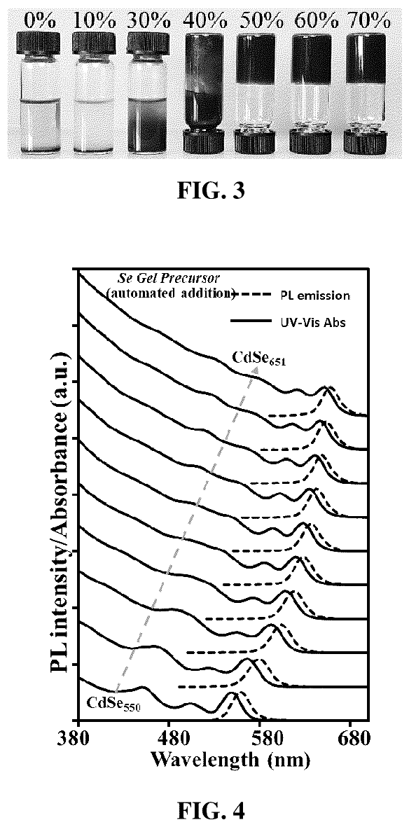

Vaseline, ODE and Se powder were configured into selenium gels where the volume fraction of Vaseline to the total volume of the liquid (V_{Vaseline}/(V_{Vaseline}+V_{ODE})) was 0%, 10%, 30%, 40%, 50%, 60%, 70%, respectively. The selenium gels with different volume fractions of Vaseline were placed in vials and stored under the same conditions for 1 week and the photograph is shown in FIG. 3.

Synthesis of CdSe nanocrystals with an average diameter of 6 nm (first exciton absorption peak at 650 nm) using Se gel precursor and Cd(Ol)₂ gel precursor

Se powder (0.237 g, 3.0 mmol) was suspended in ODE (5 mL) by sonication for 5 min, into which melted Vaseline (5.0 mL) was added to form the Se-Gel. Cd(Ol)₂ gel precursor (Cd(Ol)₂-Gel, 0.15M) was prepared by dispersing Cd(Ol)₂ made by dissolving CdO powder (0.385 g, 3.0 mmol) in oleic acid (10.0 mL) in melted Vaseline (10.0 mL). In a typical synthesis, CdO (0.020 g, 1.6 mmol), stearic acid (1.280 g, 4.5 mmol) and lauric acid (1.322 g, 6.6 mmol) were loaded into a 50 mL three-neck flask with 10.0 mL of ODE. After stirring and argon bubbling for 10 min, the mixture was heated to 250° C. by a digital-controlled heating mantle to obtain a colorless solution, and then, the ODE solution (1.0 mL) containing 0.36 μmol of the purified CdSe seeds obtained above was injected into the reaction solution. About 2.5 min later, the Se-gel (2.0 mL) and Cd(Ol)₂-Gel (5.0 mL) were separated loaded into two syringes and dropwise added into the reaction flask at 0.63 mL/h and at 1.26 mL/h through automated syringe pumps, respectively. When the desired size was reached, the reaction was stopped by cooling down to room temperature in air. The purification procedure was the same as that described above.

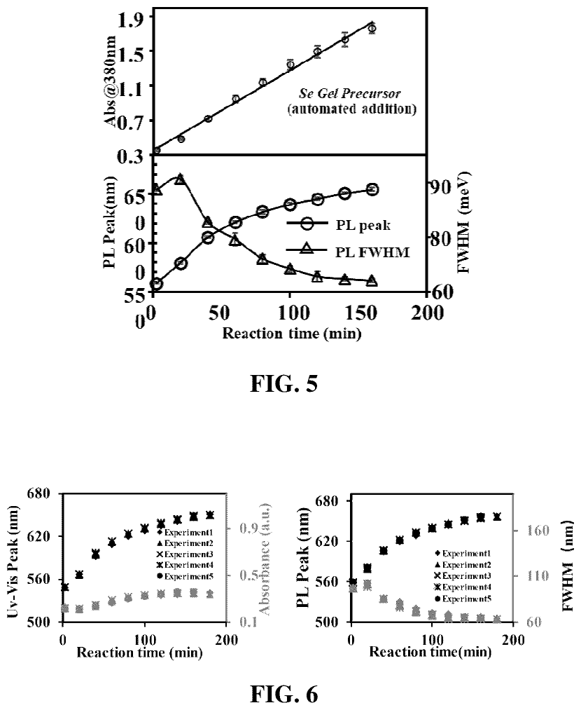

The temporal evolution of UV-vis absorption and photoluminescence spectra of CdSe nanocrystals with dropwise addition of Se gel precursor is shown in FIG. 4. The change in absorbance of CdSe nanocrystals at 380 nm and the change in the PL peak position and full width at half maxima (FWHM) of CdSe nanocrystals during the reaction were monitored to obtain FIG. 5, where the error bars give the deviation between the five replicated experiments. The high reproducibility of the five sets of experiments can be further seen from FIG. 6.

### Example 3

Synthesis of CdS nanocrystals with gel precursor.

N,N′-Di-n-butylthiourea (0.188 g, 1.0 mmol) was dispersed in ODE (5 mL) by agitation for 5 min at 80° C., into which melted Vaseline (5.0 mL) was added to form N,N′-Di-n-butylthiourea gel precursor (thiourea Gel-Precursor). The S-ODE precursor (S-ODE, 0.1M) was prepared by dispersing S powder (0.032 g, 1.0 mmol) in ODE (10.0 mL) by sonication for 5 min. Cd(Ol)₂-ODE solution (0.1M) was prepared by dispersing CdO powder (0.128 g, 1.0 mmol) in oleic acid (1.1380 g, 4.0 mmol) by agitation for 60 min at 100° C., into which ODE (8.7 mL) was added.

In a typical synthesis of CdS nanocrystals, CdO (0.026 g, 0.2 mmol) and stearic acid (0.171 g, 0.6 mmol) were loaded into a 50 mL three-neck flask with 6.0 mL of ODE. After stirring and argon bubbling for 10 min, the mixture was heated to 280° C. The temperature was reduced to 250° C., and 1 mL of the S-ODE was injected quickly into the hot solution. The reaction temperature was kept at 250° C. for 5 min further growth. The temperature was reduced to 150° C., thiourea gel precursor (5.0 mL) and Cd(Ol)₂-ODE (5.0 mL) were separately loaded into two syringes and dropwise added into the reaction flask at 1.0 mL/h by automated syringe pumps. Aliquots (˜0.05 mL) were taken for UV-vis and PL measurements to monitor the reaction. When the desired size was reached, the reaction was stopped by cooling down to room temperature in air. After cooling, the reaction mixture (4 mL) was loaded into a 20 mL vial. Into the vial, 8 mL ethyl acetate was added. After vortexing and centrifugation at 4000 rpm, the supernatant was removed. The precipitate was dissolved in ˜3 mL toluene. 3 mL methanol was added at room temperature and the mixture was heated at 85° C. under magnetic stirring for 50 min. After centrifuging at 4000 rpm, the supernatant was removed. The precipitation was repeated twice.

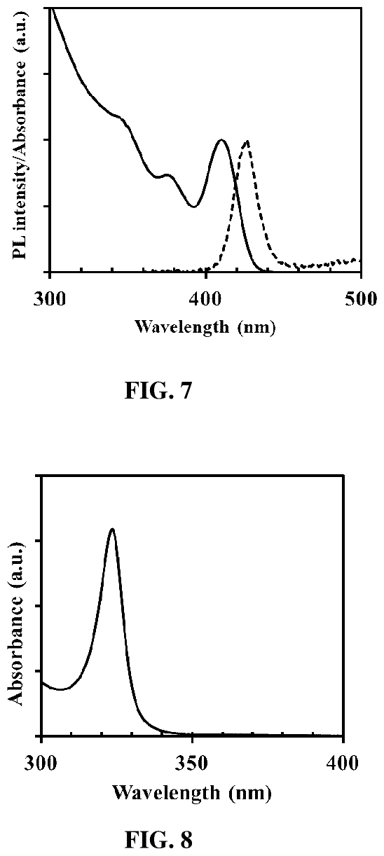

The UV-vis absorption and photoluminescence spectra of the typical CdS nanocrystals obtained are shown in FIG. 7.

In a typical synthesis of CdS cluster, CdO (0.026 g, 0.2 mmol) and stearic acid (0.171 g, 0.6 mmol) were loaded into a 25 mL three-neck flask with 6.0 mL of ODE. After stirring and argon bubbling for 10 min, the mixture was heated to 280° C. Consequently, the temperature was reduced to 150° C., and one dose of the thiourea gel precursor (5.0 mL) was loaded into a syringe and dropwise added into the reaction flask at 1.0 mL/h by an automated syringe pump. Aliquots (˜0.05 mL) were taken for UV-vis and PL measurements to monitor the reaction. The UV-vis absorption spectrum of the typical ultra-small size CdS clusters obtained is shown in FIG. 8.

### Example 4

Synthesis of ZnSe nanocrystals with Se gel precursor and Zn₅(CO₃)₂(OH)₆ gel precursor.

Se gel precursor (Se-Gel, 0.4M) was prepared using the method described above. Zinc carbonate hydroxide (0.4376 g, 0.8 mmol) was dispersed in ODE (5 mL) by sonication for 5 min, into which melted Vaseline (5.0 mL) was added to form Zn₅(CO₃)₂(OH)₆ gel precursor (Zn₅(CO₃)₂(OH)₆-Gel, 0.08M).

In a typical synthesis, Zn(St)₂(0.3162 g, 0.5 mmol) were loaded into a 25 mL three-neck flask with 5.0 mL of ODE. After stirring and argon bubbling for 10 min, the mixture was heated to 290° C. 0.4M Se-Gel (0.8 mL, prepared above) was injected quickly into the reaction flask at 290° C. After reacting for 8 min, the Se-Gel (10.0 mL) and Zn₅(CO₃)₂(OH)₆-Gel (10.0 mL) were separately loaded into two syringes and dropwise added at 2.4 mL/h by automated syringe pumps. Aliquots (˜0.05 mL) were taken for UV-vis and PL measurements to monitor the reaction. When the desired size was reached, the reaction was stopped by cooling down to room temperature in air. Purification of the ZnSe NCs was carried out as follows. An equal volume of acetone was mixed with the reaction mixture and centrifuged. After decantation, the precipitate was dissolved in 4.0 mL toluene with a small amount of n-octylamine (0.06 mL). Acetonitrile (4.0 mL) was added into the solution to precipitate the ZnSe nanocrystals. Re-dissolution of the precipitate in hexane/toluene and re-precipitation by acetonitrile (hexane:toluene:acetonitrile=1:1:1, 6 mL in total) were repeated for eight times. The final precipitate of ZnSe nanocrystals were dispersed in 1.0 mL octane for further experiments. This purification process was applied to another type of ZnSe nanocrystals described in Example 5 below and the CdSe/ZnSe core-shell nanocrystals described in Example 9.

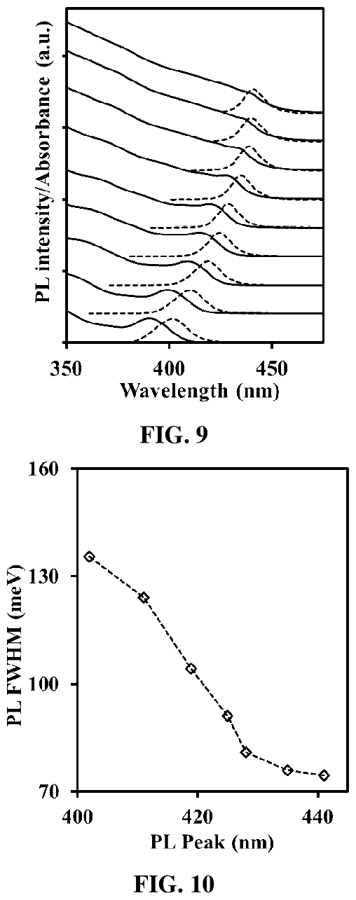

FIG. 9 illustrates the UV-vis absorption and photoluminescence spectra of ZnSe nanocrystals of different sizes prepared in Example 4; and FIG. 10 illustrates the change curves of the PL FWHM and the positions of the PL peaks of ZnSe nanocrystals of different sizes prepared in Example 4.

### Example 5

Synthesis of ultra-narrow blue-emitting ZnSe nanocrystals with Se-Gel and Zn(Acac)₂ gel precursor.

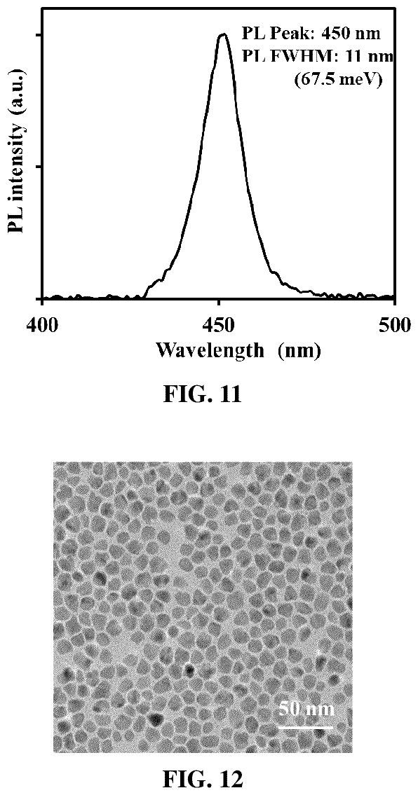

Zinc (II) acetylacetonate (0.5272 g, 2 mmol) was dispersed in ODE (5 mL) by sonication for 5 min, into which melted Vaseline (5.0 mL) was added to form zinc acetylacetonate gel precursor (Zn(Acac)₂-Gel, 0.2M). In a typical synthesis, ODE (2.0 mL) was loaded into a 25 mL three-neck flask. After stirring and argon bubbling for 10 min, the liquid was heated to 290° C. Unpurified ZnSe nanocrystals synthesized above (2.0 mL, PL peak at 440 nm) was injected into the reaction flask. After holding for 5 min, the Se-gel (10.0 mL) and Zn(Acac)₂-gel (10.0 mL) were loaded in two separate syringes and dropwise added into the reaction flask at 2.4 mL/h by automated syringe pumps. Aliquots (˜0.05 mL) were taken for UV-vis and PL measurements to monitor the reaction. When the desired size was reached, the reaction was stopped by cooling down to room temperature in air. The photoluminescence spectrum, TEM photograph of typical ZnSe nanocrystals obtained is shown in FIGS. 11 and 12, respectively.

### Example 6

Synthesis of 5.5 monolayer zinc blende CdSe nanoplatelets using Cd(Ac)₂ gel precursor.

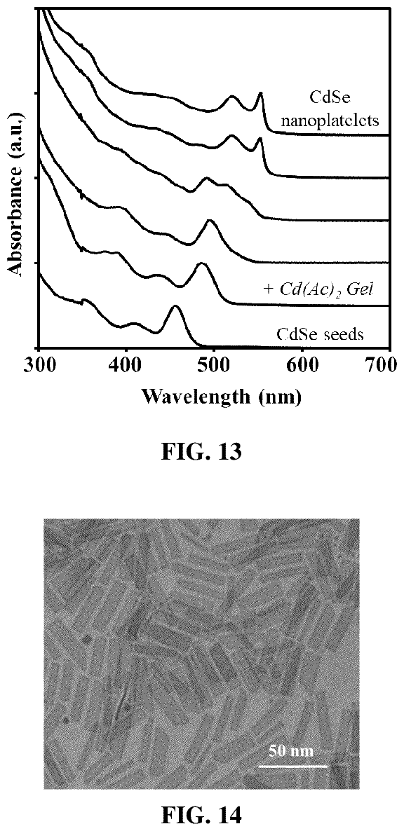

Cadmium acetate dihydrate (0.5272 g, 1.5 mmol) was milled into fine powders and suspended in ODE (6 mL) by agitation for 5 min, into which melted Vaseline (4.0 mL) was added to form Cd(Ac)₂ gel precursor (0.15M). In a typical synthesis of zinc-blende 5.5-monolayer CdSe nanoplatelets, CdSt₂ (0.020 g, 1.6 mmol) were loaded into a 25 mL three-neck flask with 4.0 mL of ODE. After stirring and argon bubbling for 10 min, the mixture was heated to 240° C. under argon protection, and then, Se-Gel (1.0 mL) was injected into the flask. When the first excitonic absorption peak of the nanocrystals shifted to ˜490 nm, Cd(Ac)₂ gel precursor (1.0 mL) was injected into the flask. The reaction was kept at 240° C. under argon protection for about 20 min before being stopped by allowing the reaction mixture cooling in air. Aliquots were taken for monitoring the reaction by UV-vis absorption spectroscopy. The UV-vis absorption spectra of the products during the monitored reaction are shown in FIG. 13. The TEM photograph of the prepared obtained CdSe nanoplatelets is shown in FIG. 14.

### Example 7

Synthesis of hexahedral CdSe/CdS core/shell nanocrystals using Cd(OH)₂ gel precursor.

Elemental S powder (0.032 g, 1.0 mmol) was dispersed in ODE (9.3 mL) by sonication for 5 min, into which oleic acid (HO1, 0.424 g, 1.5 mmol) and capric acid (HCa, 0.086 g, 0.5 mmol) were added to the dispersion to form the S precursor. Cadmium hydroxide (0.146 g, 1.0 mmol) was dispersed in ODE (5 mL), into which melted Vaseline (5.0 mL) was added to form Cd(OH)₂ gel precursor (0.1M). In a typical synthesis, CdO (0.0128 g, 0.1 mmol), oleic acid (0.127 g, 0.45 mmol), and capric acid (HCa, 0.025 g, 0.15 mmol) were loaded into a 25 mL three-neck flask with 4.0 mL of ODE. After stirring and argon bubbling for 10 min, the mixture was heated to 250° C. by a digital-controlled heating mantle to obtain a colorless solution, and then, the ODE solution containing 0.18 μmol of CdSe seed nanocrystals described above was injected into the reaction solution. After holding for 2.0 min, the S-ODE precursor (5.0 mL) and Cd(OH)₂ gel precursor (5.0 mL) were loaded into two separate syringes and dropwise added into the reaction flask at 2.0 mL/h by automated syringe pumps. Aliquots (˜0.05 mL) were taken for UV-vis and PL measurements to monitor the reaction. When the desired size was reached, the reaction was stopped by cooling down to room temperature in air. It is inferred that the ligands of the above core/shell nanocrystals are hydroxides and carboxylates. The CdSe/CdS core/shell nanocrystals prepared in Example 7 were tested for ligand quantity ratio. Utilizing a negatively charged (−1 valence) ligand can be replaced one-for-one with another negatively charged (−1 valence) ligand, and thus can be replaced by a thiolate ligand. Since each carboxylate and thiolate ligand is capped with a methyl group, the difference in absorbance of the methyl group (as determined by carbon tetrachloride liquid-phase FTIR) gives the proportion of hydroxide ligands that are not methyl-capped in the original CdSe/CdS core/shell nanocrystals. The test results showed about 20% of hydroxide ligands in the CdSe/CdS core/shell nanocrystals.

### Example 8

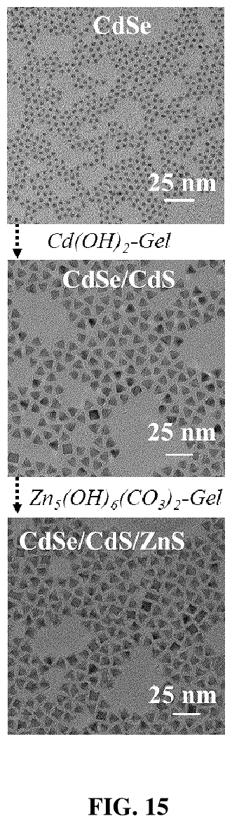

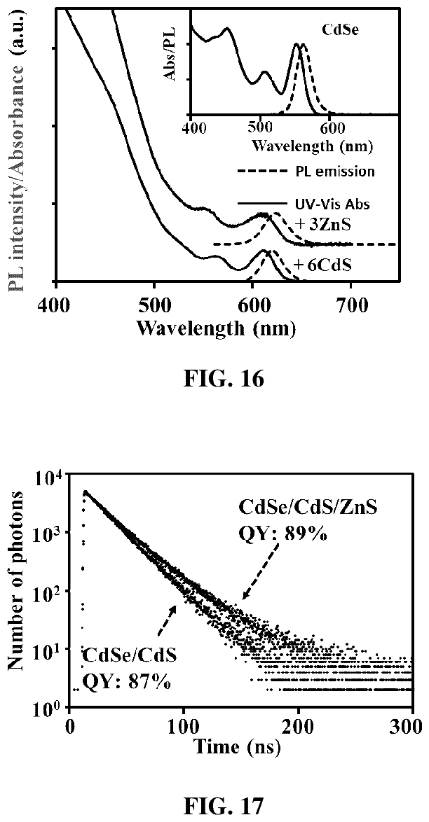

Zn₅(CO₃)₂(OH)₆ (0.109 g, 0.2 mmol) was dispersed in ODE (5 mL) by agitation for 5 min, into which melted Vaseline (5.0 mL) was added to form Zn₅(CO₃)₂(OH)₆ gel precursor (Zn₅(CO₃)₂(OH)₆-Gel, 0.02M). In a typical synthesis, Zinc acetate dehydrate (Zn(Ac)₂·2H₂O, 0.0220 g, 0.1 mmol), oleic acid (0.127 g, 0.45 mmol), and capric acid (HCa, 0.025 g, 0.15 mmol) were loaded into a 25 mL three-neck flask with 4.0 mL of ODE. After stirring and argon bubbling for 10 min, the mixture was heated to 250° C. by a digital-controlled heating mantle to obtain a colorless solution, and then, the ODE solution containing ˜0.05 μmol of CdSe/CdS core/shell nanocrystals with 6 monolayers of the CdS shells was injected into the reaction solution. After holding for 2.0 min, the S-ODE (5.0 mL) and Zn₅(CO₃)₂(OH)₆-Gel (5.0 mL) were loaded into two separate syringes and dropwise added into the reaction flask at 2.0 mL/h by automated syringe pumps. Aliquots (˜0.05 mL) were taken for UV-vis and PL measurements to monitor the reaction. When the desired size was reached, the reaction was stopped by cooling down to room temperature in air. TEM photographs of the products during the reactions of Examples 7-8 are shown in FIG. 15. FIG. 16 illustrates the UV-vis and PL spectra of the CdSe/CdS and CdSe/CdS/ZnS nanocrystals obtained in Examples 7-8. FIG. 17 illustrates the transient fluorescence spectra of CdSe/CdS and CdSe/CdS/ZnS nanocrystals obtained in Examples 7-8, where the quantum yield (QY) was increased from 87% to 89% after ZnS coating.

### Example 9

Preparation of CdSe/ZnSe core/shell nanocrystals using Se-Gel and Zn(Acac)₂ gel precursor.

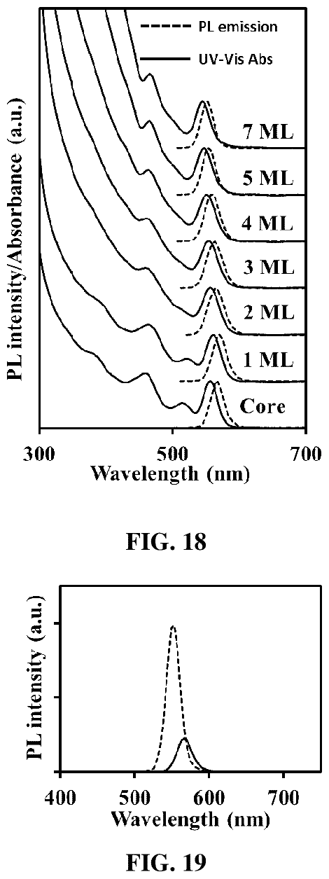

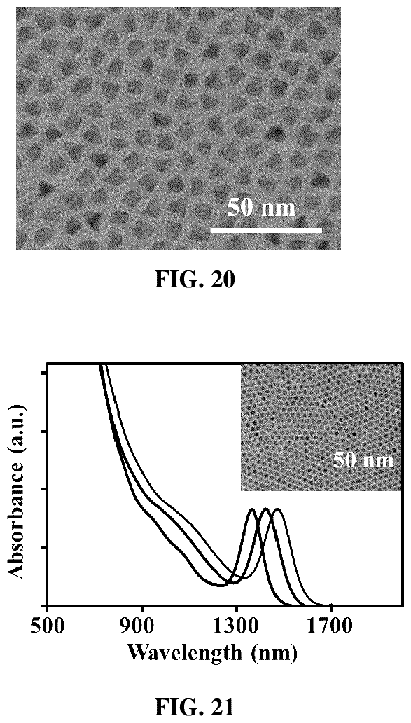

Se gel precursor (0.1M, 50% Vaseline) and Zn(Acac)₂ gel precursor (0.1M, 50% Vaseline) were prepared using the methods described above. In a typical synthesis, Zn(St)₂(0.0316 g, 0.05 mmol) was loaded into a 25 mL three-neck flask with 4.0 mL of ODE. After stirring and argon bubbling for 10 min, the mixture was heated to 290° C. And then, the ODE solution containing 0.18 μmol of CdSe core nanocrystals described above was injected into the reaction solution. After holding for 5 min, the Se gel precursor (10.0 mL) and Zn(Acac)₂ gel precursor (10.0 mL) were separately loaded into two syringes and dropwise added into the reaction flask at 2.0 mL/h by automated syringe pumps. Aliquots (˜0.05 mL) were taken for UV-vis and PL measurements to monitor the reaction. When the desired size was reached, the reaction was stopped by cooling down to room temperature in air. CdSe/ZnSe nanocrystals with different number of monolayers were prepared by calculating the amount of precursor dropwise addition and controlling the time of precursor dropwise addition. FIG. 18 illustrates the UV-vis and PL spectra of the CdSe cores used in Example 9 and the CdSe/ZnSe nanocrystals obtained with different numbers of monolayers. The “ML” in FIG. 18 stands for monolayer. FIG. 19 illustrates the PL spectra of the CdSe core used in Example 9 and the CdSe/ZnSe nanocrystals with 1 monolayer ZnSe shell layer at the same excitation intensity. FIG. 20 illustrates a TEM photograph of CdSe/ZnSe nanocrystals with a 7 monolayered ZnSe shell layer prepared in Example 9.

### Example 10

Synthesis of PbS nanocrystals with N,N′-Di-n-butylthiourea gel precursor.

The thiourea gel precursor (0.1M) was prepared using the method described above. In a typical synthesis, lead oleate (Pb(Ol)₂, 0.116 g, 0.15 mmol) was loaded into a 25 mL three-neck flask with 4.0 mL of ODE. After stirring and argon bubbling for 10 min, the mixture was heated to 150° C., and 1 mL of the thiourea gel precursor was injected quickly into the hot solution. The reaction temperature was kept at 150° C. for growth of PbS nanocrystals. Aliquots (about 0.05 mL) were taken for UV-vis and PL measurements to monitor the reaction. When the desired size was reached, the reaction was stopped by cooling down to room temperature in air. After cooling, the reaction mixture (2.5 mL) was loaded into a 10 mL centrifuge tube. Into the centrifuge tube, 5 mL ethyl acetate was added. After vortexing and centrifugation at 10000 rpm, the supernatant was removed. The precipitate was dissolved in about 2 mL toluene. 4 mL ethyl acetate was added at room temperature. After centrifuging at 10000 rpm, the supernatant was removed. The precipitation was repeated twice.

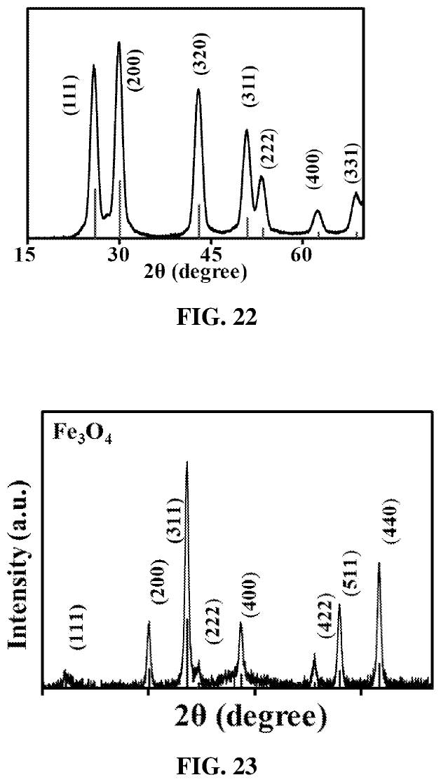

FIG. 21 illustrates a UV-vis spectra of the PbS nanocrystals of Example 10, with the inset showing a TEM photograph thereof. FIG. 22 illustrates an XRD plot of the PbS nanocrystal powder of Example 10.

### Example 11

Synthesis of PbSe nanocrystals with Se gel precursor.

The Se-Gel precursor (0.1M) was prepared by the procedure described above. In a typical synthesis, lead oleate (Pb(Ol)₂, 0.155 g, 0.2 mmol) was loaded into a 25 mL three-neck flask with 6.0 mL of ODE. After stirring and argon bubbling for 10 min, the mixture was heated to 220° C., and 1 mL of the Se-Gel was injected quickly into the hot solution. The reaction temperature was kept at 220° C. for growth of PbSe nanocrystals. Aliquots (˜0.05 mL) were taken for UV-vis and PL measurements to monitor the reaction. When the desired size was reached, the reaction was stopped by cooling down to room temperature in air. After cooling, the reaction mixture (5 mL) was loaded into a 20 mL vial. Into the vial, 10 mL acetone was added. After vortexing and centrifugation at 4000 rpm, the supernatant was removed. The precipitate was dissolved in ˜4 mL hexane. 8 mL acetone was added at room temperature. After centrifuging at 4000 rpm, the supernatant was removed. The precipitation was repeated twice.

### Example 12

Synthesis of Fe₃O₄ nanocrystals with Fe(Acac)₃ gel precursor.

Ferric acetylacetonate (1.766 g, 5.0 mmol) was mixed with oleic acid (HO1, 4.237 g, ˜4.8 mL) by agitation for 5 min, into which the melted Vaseline (5.2 mL) was added to form Frrric acetylacetonate gel precursor (Fe(Acac)₃ gel precursor, 0.5M). In a typical synthesis, ODE (4.0 mL) was loaded into a 25 mL three-neck flask. After stirring and argon bubbling for 10 min, the mixture was heated to 300° C. The Fe(Acac)₃ gel precursor (5.0 mL) was loaded into a syringe and dropwise added into the reaction flask at 2.0 mL/h by an automated syringe pump. After reaction for 30 min, the reaction was stopped by cooling down to room temperature in air. After cooling, the reaction mixture (5 mL) was loaded into a 20 mL vial. Into the vial, 10 mL ethyl acetate was added. After vortexing and centrifugation at 4000 rpm, the supernatant was removed. The precipitate was dissolved in ˜4 mL toluene. 8 mL acetone was added at room temperature. After centrifuging at 4000 rpm, the supernatant was removed. The precipitation was repeated twice.

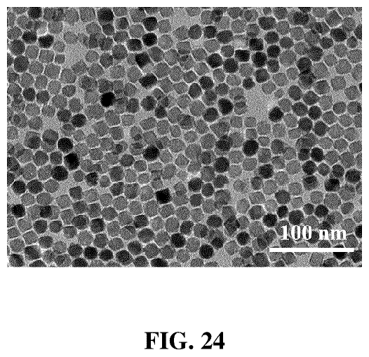

FIG. 23 illustrates an XRD plot of Fe₃O₄ nanocrystals obtained by the preparation of Example 12. FIG. 24 illustrates a TEM photograph of Fe₃O₄ nanocrystals obtained by the preparation of Example 12.

### Example 13

Preparation of In(Acac)₃ gel precursor or In(Ac)₃ gel precursor using the above methods and synthesizing InP nanocrystals.

In(Acac)₃ gel precursor (0.06M) or In(Ac)₃ gel precursor (0.06M) was prepared using the method described above. InP nanocrystals were synthesized through two consecutive steps, i.e., formation of small ones through direct injection of the phosphorus precursors into an ODE solution with dissolved indium fatty acid salts and continuous growth of the small InP nanocrystals by secondary injections of the anionic precursor and cationic gel precursor. For a typical synthesis, In(Ac)₃ (0.125 mmol) and 0.375 mmol myristic acid (HMy) were heated to 150° C. in a 10 mL flask, and annealed for 30 min to remove acetic acid under a flow of argon. Trioctylphosphine (0.5 mL) and ODE (3.5 mL) were added into the solution. After being kept at 150° C. for 10 min, the mixture was decreased to 100° C. A solution containing 0.05 mmol of (TMS)₃P in ODE (0.8 mL in total) was rapidly injected at 100° C. and the reaction temperature was set to 270° C. for the growth of InP nanocrystals. After 15 minutes, the growth of InP nanocrystals reached a plateau, additional (TMS)₃P in ODE was added in the solution for further growth of InP NCs, while ramping the temperature from 270° C. down to 150° C. In(Acac)₃ gel precursor (0.06 mmol) or In(Ac)₃ gel precursor (0.06 mmol) was added into the reaction solution for surface activation and secondary indium precursor for growth of InP nanocrystals. After 30 min at 150° C., 0.5 mL of a 0.12 mol/L (TMS)₃P-ODE solution was dropwise added. When the desired size of InP QDs was reached, the reaction mixture was allowed to cool down to room temperature by removing the heating mantle.

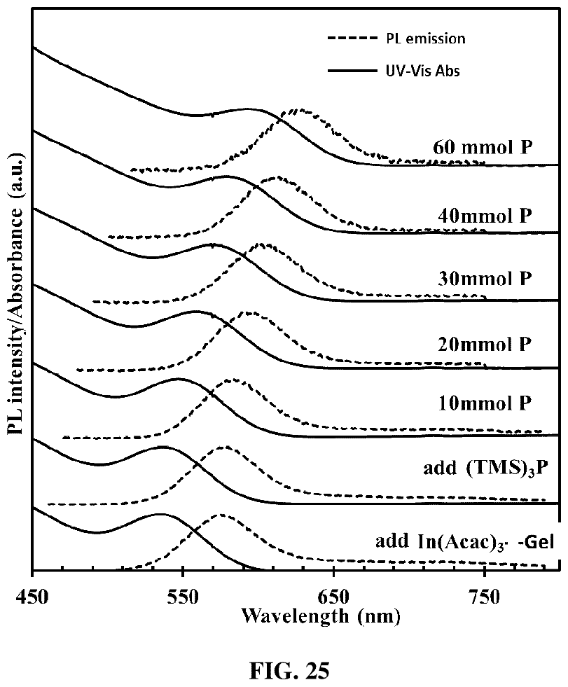

FIG. 25 illustrates the UV-vis and PL spectra of the nanocrystals obtained by adding different P precursors during the reaction of Example 13.

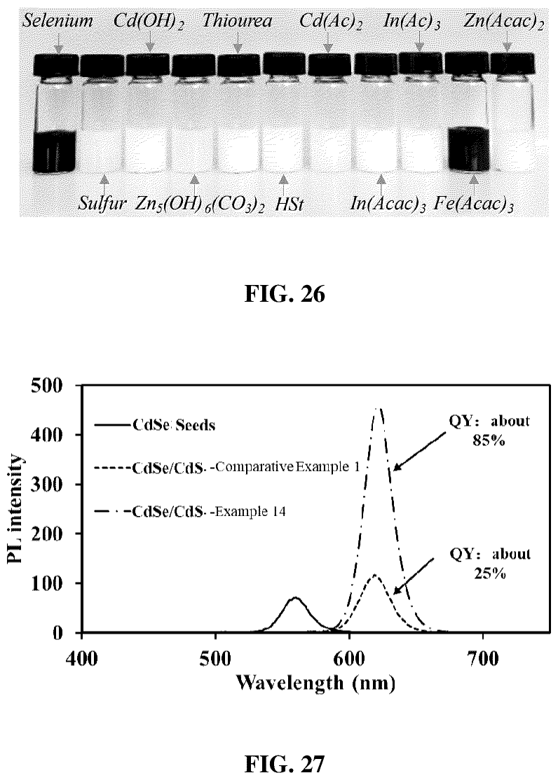

Photographs of the gel-like precursor compositions used in various examples are shown in FIG. 26. Table 1 summarizes the precursors used in various embodiments.

TABLE 1

| Serial | | |
|---|---|---|
| number | Nanocrystal | Precursors used |
| Examples | CdSe | Selenium + Cd(Ol)₂ |
| 1&2 | | |
| Example 3 | CdS | Sulfur, N,N′-di-n-butylthiourea |
| Example 4 | ZnSe | Selenium + Zn₅(OH)₆(CO₃)₂ |
| Example 5 | ZnSe | Selenium + Zn(Acac)₂ |
| Example 6 | CdSe | Cd(Ac)₂ |
| | nanoplatelets | |
| Example 7 | CdSe/CdS | Selenium + Cd(OH)₂ |
| Example 8 | CdSe/CdS/ZnS | Selenium + Cd(OH)₂+ Zn₅(OH)₆(CO₃)₂ |
| Example 9 | CdSe/ZnSe | Selenium + Zn(Acac)₂ |
| Example 10 | PbS | N,N′-di-n-butylthiourea |
| Example 11 | PbSe | Selenium |
| Example 12 | Fe₃O₄ | Fe(Acac)₃ |
| Example 13 | InP | In(Ac)₃, In(Acac)₃ |

The optical properties of the nanocrystals prepared in each example are summarized in Table 2. The lead-based nanocrystals failed to measure fluorescence under laboratory conditions. The iron tetraoxide nanocrystals were mainly magnetic in nature and did not fluoresce.

TABLE 2

| | PL peak | PL full width at |
|---|---|---|
| Example | position (nm) | half maxima (nm) |
| Example 1 CdSe | 560 | 23.5 |
| Example 2 CdSe | 656 | 22.0 |
| Example 3 CdS | 426 | 16.7 |
| Example 4 ZnSe | 440 | 11.5 |
| Example 5 ZnSe | 450 | 11.0 |
| Example 6 CdSe | 550 | 11.0 |
| Example 7 CdSe/CdS | 623 | 25.8 |
| Example 8 CdSe/CdS/ZnS | 628 | 29.3 |
| Example 9 CdSe/ZnSe | 551 | 21.9 |
| Example 10 PbS | — | — |
| Example 11 PbSe | — | — |
| Example 12 Fe₃O₄ | — | — |
| Example 13 InP | 626 | 55.7 |

### Example 14

Synthesis of CdSe/CdS core/shell nanocrystals with Cd(OH)₂.

Step 1:0.1 mmol CdO was placed in a 25 mL three-necked flask, 0.45 mmol oleic acid (OA) and 0.15 mmol decanoic acid were added. After the experimental device was set up, argon gas was passed and the temperature was raised to 150° C. The stirring was gently turned on (first gear) for a period of time.

Step 2: After the solution was clarified, 4 mL of ODE was injected, while the temperature was raised to 250° C. The solution was then heated up to 250° C. After the temperature was stabilized, CdSe nanocrystals (purified, 0.18μmmol) with the first exciton absorption peak of 550 nm were rapidly injected.

Step 3: After 1 min, the drop rate was controlled to be 2 mL/h, and 0.1M Cd(OH)₂ gel was added to the flask simultaneously with a mixture of S precursor, which consisted of 0.1M S, 0.15M OA, 0.05M chloroacetic acid (CA) and ODE.

Step 4: Reaction for 150 min. During the reaction, a certain amount of reaction solution was injected into a quartz surface dish containing 2.3 mL of toluene. UV-vis absorption spectrum and photoluminescence spectrum measurements were performed. When the nanocrystals reached a predetermined size, the heating was stopped immediately.

### Comparative Example 1

Synthesis of CdSe/CdS core/shell nanocrystals with Cd(OA)₂ and Cd(CA)₂.

Steps 1 and 2 were the same as in Example 14.

Step 3: After 1 min, a drop rate of 2 mL/h was controlled, and a gel-like Cd precursor composition including 0.075M Cd(OA), 0.025M Cd(CA), 0.15M OA, 0.05M CA, and Vaseline were added dropwise into the flask simultaneously with 0.1 M S-ODE solution. The reaction was carried out for 170 min.

Step 4: During the reaction, a certain amount of reaction solution was injected into a quartz surface dish containing 2.3 mL of toluene. Measurements of UV-vis absorption spectrum and photoluminescence spectrum were carried out. When the nanocrystals reached a predetermined size, the heating was stopped immediately.

As can be seen from FIG. 27 of the experimental results for both Example 1 and Example 14, both using gel-like precursor compositions, but the nanocrystalline surfaces of Example 14 are presumed to have a higher amount of hydroxide ligands compared to Example 1, confirming that nanocrystalline hydroxide ligands have a significant positive impact on nanocrystals to improve QY compared to common carboxylate ligands. This is an additional benefit that the organogel medium brings while expanding the precursor selection range of precursors.

The foregoing is only a preferred embodiment of the present disclosure, and is not intended to limit the present disclosure, which is subject to various changes and variations for those skilled in the art. Any modifications, equivalent substitutions, improvements, etc. made within the spirit and principles of the present disclosure shall be included in the scope of protection of the present disclosure.

What is claimed is:

1. A precursor composition, wherein the precursor composition is used to prepare inorganic nanocrystals and is in the form of a gel, the precursor composition comprising a precursor and an organogel medium for dispersing the precursor, the precursor being one or more of a cationic precursor, an anionic precursor.

2. The precursor composition according to claim 1, wherein the organogel medium comprises hydrocarbons of different chain lengths.

3. The precursor composition according to claim 1, wherein the organogel medium is Vaseline.

4. The precursor composition according to any one of claims 1-3, wherein the precursor composition further comprises a hydrocarbon solvent.

5. The precursor composition according to claim 4, wherein the hydrocarbon solvent is 1-octadecene.

6. The precursor composition according to claim 5, wherein the volume ratio of the hydrocarbon solvent to the organogel medium is less than or equal to 4.

7. The precursor composition according to claim 4, wherein the hydrocarbon solvent has a boiling point greater than or equal to 150° C.

8. The precursor composition according to claim 4, wherein the precursor is selected from one or more of the group consisting of a metal hydroxide, a metal carbonate, a metal carboxylate, an acetylacetonate metal salt, a Se powder, a S powder or a thiourea derivative.

9. The precursor composition according to claim 4, wherein the precursor composition further comprises an organic ligand compound for preparing inorganic nanocrystals.

10. The precursor composition according to claim 4, wherein the precursor composition further comprises a fatty acid.

11. The precursor composition according to claim 10, wherein the fatty acid has a melting point greater than or equal to 30° C.

12. A method of preparing the precursor composition as claimed in claim 1, wherein, mixing a precursor mixture liquid with a melted organogel medium, cooling to obtained the precursor composition.

13. The method of preparation according to claim 12, wherein, mixing the precursor and the hydrocarbon solvent to obtain the precursor mixture liquid, adding the melted organogel medium to the precursor mixture liquid, cooling to obtain the precursor composition.

14. The method of preparation according to claim 12, wherein the melted organogel medium is at a temperature of 70 to 80° C.

15. The method of preparation according to claim 13, wherein the process of mixing the precursor and the hydrocarbon solvent comprises mixing the precursor and the hydrocarbon solvent under sonication or agitation to obtain the precursor mixture liquid.

16. The method of preparation according to claim 13, wherein the process of mixing the precursor and the hydrocarbon solvent further comprises heating the precursor mixture liquid, but the temperature of the precursor mixture liquid is less than 100° C.

17. The method of preparation according to claim 12, wherein the metal oxide and the fatty acid are mixed and reacted to obtain the precursor mixture liquid.

18. The method of preparation according to claim 17, wherein a volume ratio of the fatty acid to the melted organogel medium is less than or equal to 0.5.

19. A method of preparing inorganic nanocrystals, wherein the preparation of the inorganic nanocrystals is carried out using the precursor composition of claim 1.

20. The method of preparation according to claim 19, in the process of preparing the inorganic nanocrystals, wherein the precursor composition is added to the reaction system in multiple supplemental additions.

21. The method of preparation according to claim 19, wherein the precursor composition comprises a metal hydroxide and the surface ligand of the prepared inorganic nanocrystals comprises hydroxide.
